(19) United States
(12) Patent Application Publication
(10) Pub. No.: US 2026/0303159 A1
(43) Pub. Date: Oct. 1, 2026

(54) PRECODING WIRELESS COMMUNICATIONS USING CLOSED-LOOP AND OPEN-LOOP TECHNIQUES

(71) Applicant: QUALCOMM Incorporated, San Diego, CA (US)

(72) Inventors: Yi HUANG, San Diego, CA (US); Kexin XIAO, Shanghai (CN); Yu ZHANG, San Diego, CA (US); Runxin WANG, San Diego, CA (US)

(21) Appl. No.: 19/480,349

(22) PCT Filed: Jul. 3, 2023
(86) PCT No.: PCT/CN2023/105465

§ 371 Date: Oct. 30, 2025

(51) Int. Cl. H04B 7/0456

(52) U.S. Cl. CPC H04B 7/0478

(57) ABSTRACT

Aspects described herein relate to a hybrid closed-loop and open-loop multiple-input multiple-output (MIMO) precoding technique including transmitting, by a first node, a reference signal to a second node, receiving, from the second node, feedback for the reference signal indicating a first precoder for communicating with the second node in a wideband, and transmitting communications to the second node in a plurality of subbands of the wideband using a plurality of precoders, where each precoder of the plurality of precoders is based at least in part on a wideband precoder that is based on the first precoder (e.g., based on a closed-loop technique) and a subband-specific precoder for a corresponding subband in the plurality of subbands, which can be based on open-loop techniques. Other aspects relate to receiving the reference signal, transmitting the feedback, and receiving the precoded communications.

### FIELD OF THE DISCLOSURE

Aspects of the present disclosure relate generally to wireless communication systems, and more particularly, to precoding multiple-input multiple-output (MIMO) communications.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to transmit a reference signal to a node, receive, from the node, feedback for the reference signal indicating a first precoder for communicating with the node in a wideband, and transmit communications to the node in a plurality of subbands of the wideband using a plurality of precoders, wherein each precoder of the plurality of precoders is based at least in part on a wideband precoder that is based on the first precoder and a subband-specific precoder for a corresponding subband in the plurality of subbands. A first subband precoder of the plurality of precoders for a first subband of the plurality of subbands is different from a second subband precoder of the plurality of precoders for a second subband of the plurality of subbands.

In another aspect, an apparatus for wireless communication is provided that includes a transceiver, one or more memories configured to, individually or in combination, store instructions, and one or more processors communicatively coupled with the one or more memories. The one or more processors are, individually or in combination, configured to execute the instructions to cause the apparatus to receive a reference signal transmitted by a node, transmitting, based on measuring the reference signal, feedback indicating a first precoder for communicating with the node in a wideband, and receiving communications from the node in a plurality of subbands of the wideband using a plurality of precoders, wherein each precoder of the plurality of precoders is based at least in part on a wideband precoder that is based on the first precoder and a subband-specific precoder for a corresponding subband in the plurality of subbands. A first subband precoder of the plurality of precoders for a first subband of the plurality of subbands is different from a second subband precoder of the plurality of precoders for a second subband of the plurality of subbands.

In another aspect, a method for wireless communication is provided that includes transmitting, by a first node, a reference signal to a second node, receiving, from the second node, feedback for the reference signal indicating a first precoder for communicating with the second node in a wideband, and transmitting communications to the second node in a plurality of subbands of the wideband using a plurality of precoders, wherein each precoder of the plurality of precoders is based at least in part on a wideband precoder that is based on the first precoder and a subband-specific precoder for a corresponding subband in the plurality of subbands, where a first subband precoder of the plurality of precoders for a first subband of the plurality of subbands is different from a second subband precoder of the plurality of precoders for a second subband of the plurality of subbands.

In another aspect, a method for wireless communication is provided that includes receiving, by a first node, a reference signal transmitted by a second node, transmitting, based on measuring the reference signal, feedback indicating a first precoder for communicating with the second node in a wideband, and receiving communications from the second node in a plurality of subbands of the wideband using a plurality of precoders, wherein each precoder of the plurality of precoders is based at least in part on a wideband precoder that is based on the first precoder and a subband-specific precoder for a corresponding subband in the plurality of subbands, where a first subband precoder of the plurality of precoders for a first subband of the plurality of subbands is different from a second subband precoder of the plurality of precoders for a second subband of the plurality of subbands.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, one or more computer-readable media are provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a receiving node, in accordance with various aspects of the present disclosure;

FIG. 4 is a block diagram illustrating an example of a transmitting node, in accordance with various aspects of the present disclosure;

FIG. 5 is a flow chart illustrating an example of a method for transmitting communications that are precoded based on a wideband precoder and one or more subband precoders for each subband in the wideband, in accordance with aspects described herein;

FIG. 6 is a flow chart illustrating an example of a method for receiving communications that are precoded based on a wideband precoder and one or more subband precoders for each subband in the wideband, in accordance with aspects described herein;

FIG. 7 illustrates examples of systems for performing downlink and uplink communications using a hybrid closed-loop and open-loop precoding technique, in accordance with aspects described herein; and

FIG. 8 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to precoding a wireless communication using a closed-loop and an open-loop technique. For example, in some wireless communication technologies, such as fifth generation (5G) new radio (NR), nodes can transmit multiple-input multiple-output (MIMO) wireless communications using a precoder that is based on feedback information from a receiving node, referred to herein as closed-loop MIMO, or without feedback from the receiving node or other knowledge of channel conditions, referred to herein as open-loop MIMO. For example, a precoder can be a matrix that can be applied to a signal for transmission before transmitting the signal to provide spatial mapping for the signal for MIMO communications.

For example, using closed-loop MIMO, a transmitting node can transmit based on feedback information from a receiving node about the channel from transmitting node to receiving node. In closed-loop MIMO, the transmitting node can transmit a reference signal (RS), the receiving node can measure the RS and/or the channel based on RS, the receiving node can report the measurement or a recommended precoder to the transmitting node as feedback, and the transmitting node can transmit communications to the receiving node using the recommended precoder or a precoder determined based on the measurements. In an example, the receiving node can indicate a recommended precoder for an entire wideband (referred to as wideband closed-loop MIMO) or for each of multiple subbands (referred to as subband closed-loop MIMO). In wideband closed-loop MIMO, the receiving node can select and indicate a single precoder for the whole bandwidth of the assigned transmission, can transmit feedback to the transmitting node indicating the single precoder, and the transmitting node can apply the single precoder on the whole bandwidth of assigned transmission. In subband closed-loop MIMO, the receiving node can select and indicate one precoder for each of multiple subbands of the whole bandwidth of the assigned transmission, can transmit feedback to the transmitting node indicating each precoder for each of the multiple subbands, and the transmitting node can apply each precoder on the corresponding subband of the assigned transmission. In this regard, wideband closed-loop MIMO can allow for reduced size feedback compared to subband closed-loop MIMO, and subband closed-loop MIMO can allow for improved precoding performance compared to wideband closed-loop MIMO.

For example, using open-loop MIMO, the transmitting node can transmit communications to the receiving node without knowledge of the channel from transmitting node to the receiving node that otherwise allows for precoder selection in closed-loop MIMO. For example, when using open-loop MIMO, the transmitting node can use diversity codes for MIMO transmissions such as space-time-block codes (STBC) or space-frequency-block codes (SFBC). Open-loop MIMO can provide efficiency as compared to closed-loop MIMO in not requiring transmission of feedback, while closed-loop MIMO can have improved precoding performance as compared to open-loop MIMO as the feedback may result in more accurate precoder determination and usage.

Aspects described herein relate to using closed-loop MIMO and open-loop MIMO techniques for precoding wireless communications to achieve benefits of both techniques. For example, closed-loop MIMO can be used to select or recommend a wideband precoder, and open-loop MIMO can be used to select a subband precoder. In an example, the transmitting node can use subband precoding for multiple subbands of the wideband, where each subband precoder can be based on both of a wideband precoder selected based on closed-loop feedback and a subband-specific precoder for the given subband that is selected without corresponding subband feedback or otherwise using open-loop MIMO. In a specific example, the wideband precoder, referred to herein as W1, can be determined using a closed-loop MIMO technique where the transmitting node determines W1 based on feedback from the receiving node, and the subband-specific precoder for each subband, referred to herein as W2(i) for subband i, can be determined using an open-loop MIMO technique that is not based on feedback. For example, the open-loop MIMO technique can include determining a fixed or predefined precoder for each subband, using a pattern of precoders that may cycle across the multiple subbands, etc.

In accordance with aspects described herein, using closed-loop MIMO for the wideband precoder can allow for achieving benefits of reduced feedback for precoder selection, as compared to closed loop MIMO for subband precoders. In addition, using open-loop MIMO for the subband precoder can allow for achieving benefits of not requiring feedback of open-loop MIMO along with diversity gains associated with subband precoders over wideband precoders. This can allow for achieving improved precoding performance across subbands as opposed to a single precoder for the wideband.

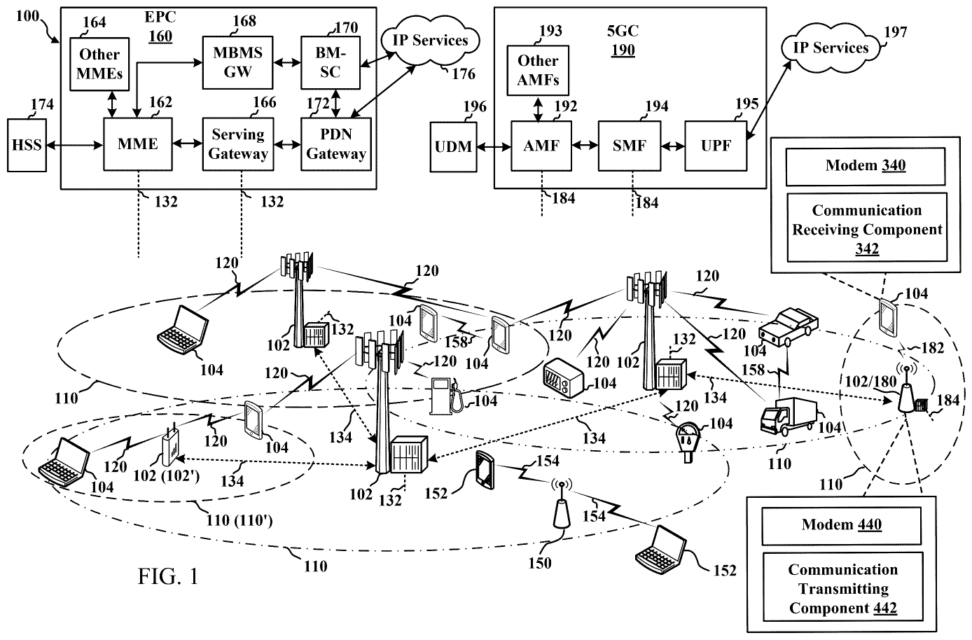

The described features will be presented in more detail below with reference to FIGS. 1-8.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS- 2000 Releases 0 and A are commonly referred to as CDMA 2000 1X, 1X, etc. IS-856 (TIA-856) is commonly referred to as CDMA 2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and communication receiving component 342 for receiving communications that are precoded based on a wideband precoder and one or more subband precoders for each subband in the wideband, in accordance with aspects described herein. In addition, some nodes may have a modem 440 and communication transmitting component 442 for transmitting communications that are precoded based on a wideband precoder and one or more subband precoders for each subband in the wideband, in accordance with aspects described herein. Though a UE 104 is shown as having the modem 340 and communication receiving component 342 and a base station 102/gNB 180 is shown as having the modem 440 and communication transmitting component 442, this is one illustrative example, and substantially any node or type of node may include a modem 340 and communication receiving component 342 and/or a modem 440 and communication transmitting component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, communication transmitting component 442 can transmit a RS, and communication receiving component 342 can receive and measure the RS. Communication receiving component 342 can transmit feedback indicating the measurement or a recommended precoder. Communication transmitting component 442 can receive the feedback, can select a precoder based on the feedback, and can transmit precoded communications based on the precoder. In accordance with aspects described herein, communication transmitting component 442 can select the precoder based on both of a wideband precoder selected based on the feedback and, for each of multiple subbands in the wideband, an associated subband-specific precoder. In an example, a base station 102/gNB 180 can include the communication transmitting component 442 for transmitting a channel state information reference signal (CSI-RS) and precoding transmissions based on feedback for the CSI-RS, and a UE 104 can include the communication receiving component 342 for receiving the reference signal, transmitting feedback, and receiving precoded communications. In another example, a UE 104 can include the communication transmitting component 442 for transmitting a sounding reference signal (SRS) and precoding transmissions based on feedback for the SRS, and a base station 102/gNB 180 (or another UE in sidelink communications) can include the communication receiving component 342 for receiving the reference signal, transmitting feedback, and receiving precoded communications.

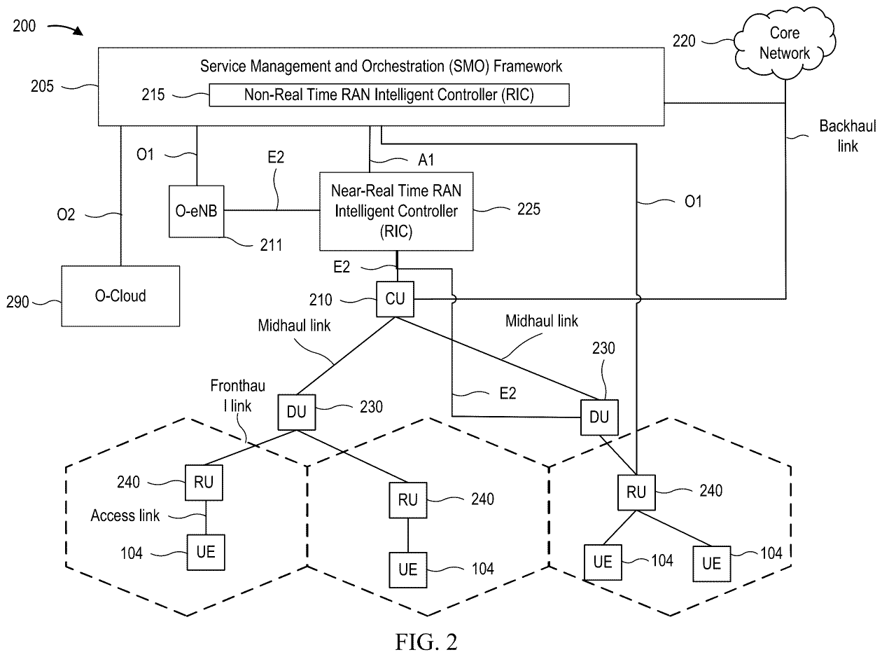

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an Al interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as Al policies).

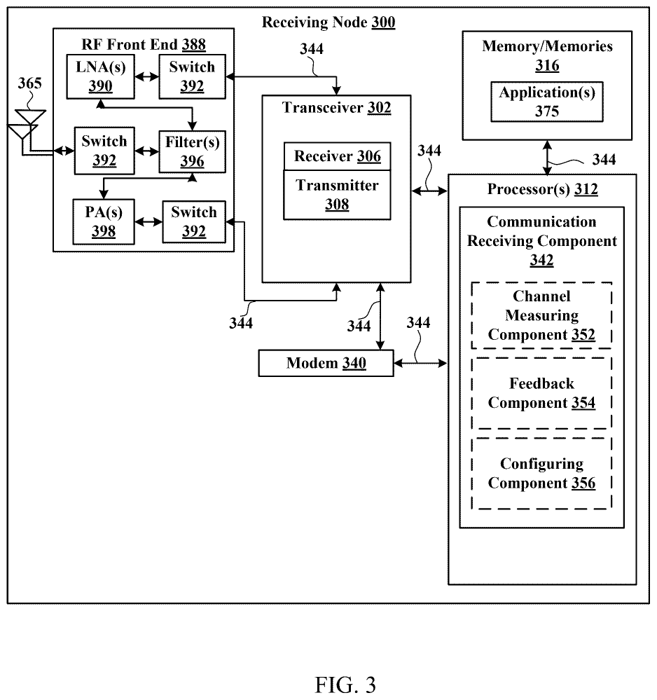

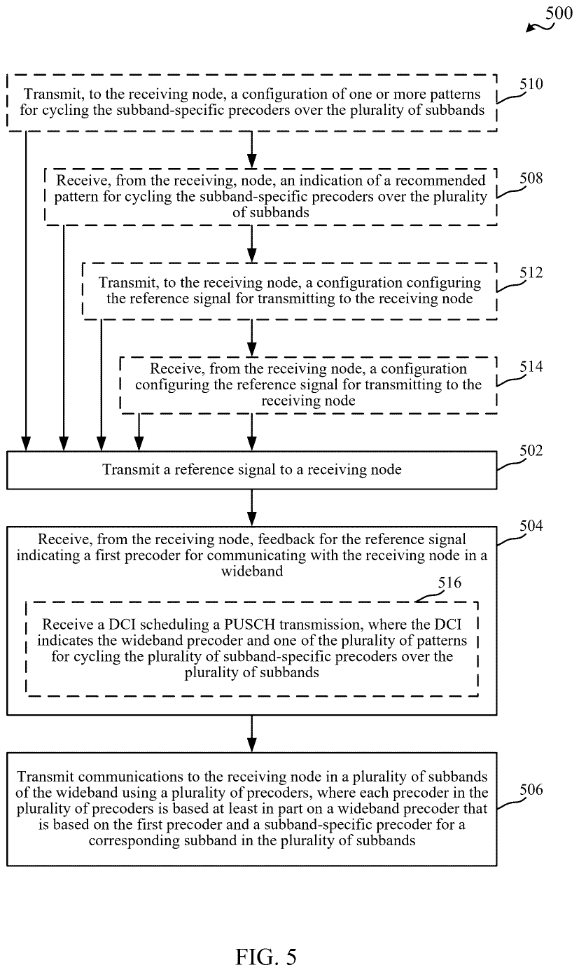

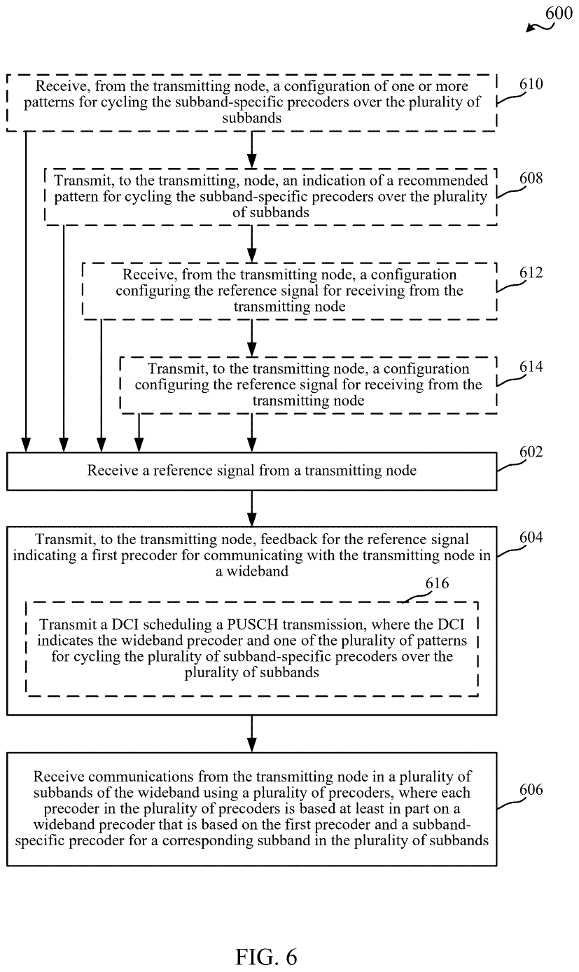

Turning now to FIGS. 3-8, aspects are depicted with reference to one or more components and one or more methods that may perform the actions or operations described herein, where aspects in dashed line may be optional. Although the operations described below in FIGS. 5-6 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of receiving node 300, such as a UE 104 in DL MIMO or a base station 102 in UL MIMO, may include a variety of components, some of which have already been described above and are described further herein, including components such as one or more processors 312 and one or more memories 316 and one or more transceivers 302 in communication via one or more buses 344. For example, the one or more processors 312 can include a single processor or multiple processors configured to perform one or more functions described herein. For example, the multiple processors can be configured to perform a certain subset of a set of functions described herein, such that the multiple processors together can perform the set of functions. Similarly, for example, the one or more memories 316 can include a single memory device or multiple memory devices configured to store instructions or parameters for performing one or more functions described herein. For example, the multiple memory devices can be configured to store the instructions or parameters for performing a certain subset of a set of functions described herein, such that the multiple memory devices together can store the instructions or parameters for the set of functions. The one or more processors 312, one or more memories 316, and one or more transceivers 302 may operate in conjunction with modem 340 and/or communication receiving component 342 for receiving communications that are precoded based on a wideband precoder and one or more subband precoders for each subband in the wideband, in accordance with aspects described herein.

In an aspect, the one or more processors 312 can include a modem 340 and/or can be part of the modem 340 that uses one or more modem processors. Thus, the various functions related to communication receiving component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with communication receiving component 342 may be performed by transceiver 302.

Also, memory/memories 316 may be configured to store data used herein and/or local versions of applications 375 or communication receiving component 342 and/or one or more of its subcomponents being executed by at least one processor 312. Memory/memories 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory/memories 316 may be a non-transitory computer-readable storage medium that stores one or more computer-executable codes defining communication receiving component 342 and/or one or more of its subcomponents, and/or data associated therewith, when receiving node 300 is operating at least one processor 312 to execute communication receiving component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by a transmitting node. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, receiving node 300 may include RF front end 388, which may operate in communication with one or more antennas 365 and transceiver 302 for receiving and transmitting radio transmissions, for example, wireless communications transmitted by at least one transmitting node or wireless transmissions transmitted by receiving node 300. RF front end 388 may be connected to one or more antennas 365 and can include one or more low-noise amplifiers (LNAs) 390, one or more switches 392, one or more power amplifiers (PAS) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that receiving node 300 can communicate with, for example, one or more transmitting nodes or one or more cells associated with one or more transmitting nodes. In an aspect, for example, modem 340 can configure transceiver 302 to operate at a specified frequency and power level based on the configuration of the receiving node 300 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of receiving node 300 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on configuration information associated with receiving node 300 as provided by the network during cell selection and/or cell reselection.

In an aspect, communication receiving component 342 can include one or more of a channel measuring component 352 for measuring a channel based on a RS received from a transmitting node, a feedback component 354 for transmitting feedback based on the channel measurement, and/or a configuring component 356 for transmitting or receiving a configuration related to at least subband-specific precoders used to precode communications received from the transmitting node.

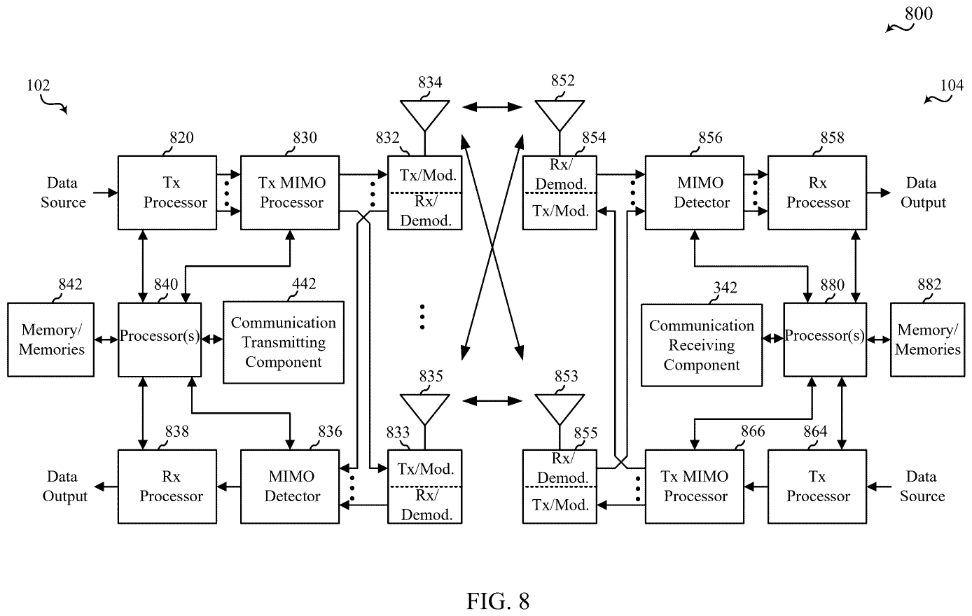

In an aspect, the processor(s) 312 may correspond to one or more of the processors described in connection with the UE in FIG. 8. Similarly, the memory/memories 316 may correspond to the memory/memories described in connection with the UE in FIG. 8.

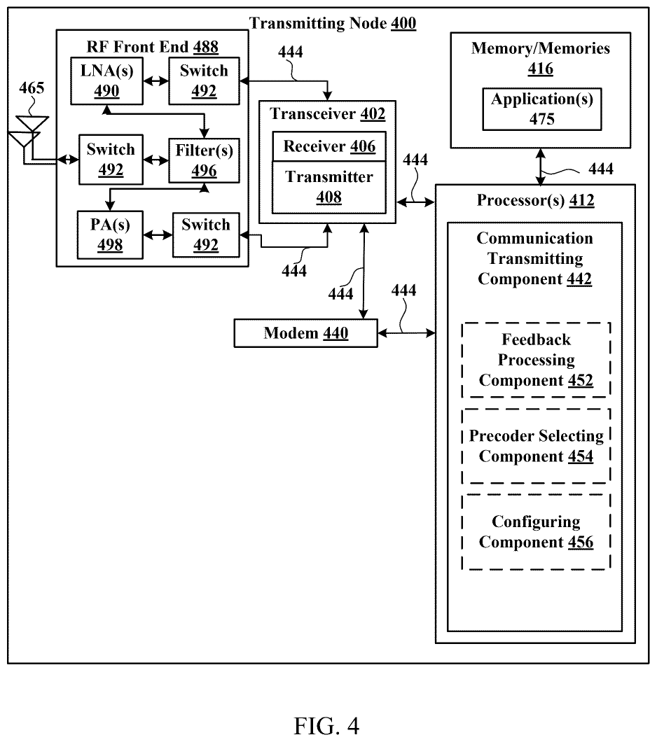

Referring to FIG. 4, one example of an implementation of transmitting node 400 (e.g., a base station 102 and/or gNB 180 in DL MIMO or a UE 104 in UL MIMO, as described above) may include a variety of components, some of which have already been described above, but including components such as one or more processors 412 and one or more memories 416 and one or more transceivers 402 in communication via one or more buses 444, which may operate in conjunction with modem 440 and communication transmitting component 442 for transmitting communications that are precoded based on a wideband precoder and one or more subband precoders for each subband in the wideband, in accordance with aspects described herein.

The one or more transceivers 402, receiver 406, transmitter 408, one or more processors 412, one or more memories 416, applications 475, buses 444, RF front end 488, LNAs 490, switches 492, filters 496, PAs 498, and one or more antennas 465 may be the same as or similar to the corresponding components of receiving node 300, as described above, but configured or otherwise programmed for transmitting node operations as opposed to receiving node operations.

In an aspect, communication transmitting component 442 can optionally include one or more of a feedback processing component 452 for processing feedback received from a receiving node regarding a transmitted RS, a precoder selecting component 454 for selecting at least a wideband precoder based on the feedback, and/or a configuring component 456 for transmitting or receiving a configuration related to at least subband-specific precoders used to precode communications transmitted to the receiving node.

In an aspect, the processor(s) 412 may correspond to one or more of the processors described in connection with the base station in FIG. 8. Similarly, the memory/memories 416 may correspond to the memory/memories described in connection with the base station in FIG. 8.

FIG. 5 illustrates a flow chart of an example of a method 500 for transmitting communications that are precoded based on a wideband precoder and one or more subband precoders for each subband in the wideband, in accordance with aspects described herein. FIG. 6 illustrates a flow chart of an example of a method 600 for receiving communications that are precoded based on a wideband precoder and one or more subband precoders for each subband in the wideband, in accordance with aspects described herein. In an example, a transmitting node 400 (e.g., a base station 102 or gNB 180, a monolithic base station or gNB, a portion of a disaggregated base station or gNB, etc. in DL MIMO or a UE 104 in UL MIMO), etc. can perform the functions described in method 500 shown in FIG. 5 using one or more of the components described in FIGS. 1 and 4, and a receiving node 300 (e.g., a UE 104 in DL MIMO or a base station 102 or gNB 180, a monolithic base station or gNB, a portion of a disaggregated base station or gNB, etc. in UL MIMO) can perform the functions described in method 600 shown in FIG. 6 using one or more of the components described in FIGS. 1 and 3. Methods 500 and 600 are described in conjunction with one another for ease of explanation; however, the methods 500 and 600 are not required to be performed together and indeed can be performed independently using separate devices.

In method 500, at Block 502, a reference signal can be transmitted to a receiving node. In an aspect, communication transmitting component 442, e.g., in conjunction with processor(s) 412, memory/memories 416, transceiver 402, etc., can transmit (e.g., from a transmitting node 400, such as base station 102 or a UE 104) the reference signal to a receiving node (e.g., receiving node 300, such as a UE 104 or base station 102). For example, where the node transmitting the reference signal is a base station 102, communication transmitting component 442 can transmit a reference signal defined for transmitting by a base station 102, such as a CSI-RS. In another example, where the node transmitting the reference signal is a UE 104, communication transmitting component 442 can transmit a reference signal defined for transmitting by a UE 104, such as a SRS.

In method 600, at Block 602, a reference signal can be received from a transmitting node. In an aspect, communication receiving component 342, e.g., in conjunction with processor(s) 312, memory/memories 316, transceiver 302, etc., can receive (e.g., at a receiving node 300, such as UE 104 or base station 102) the reference signal from a transmitting node (e.g., a transmitting node 400, such as a base station 102 or UE 104). For example, where the node receiving the reference signal is a UE 104, communication receiving component 342 can receive a reference signal defined for transmitting by a base station 102, such as a CSI-RS. In another example, where the node receiving the reference signal is a base station 102, communication receiving component 342 can receive a reference signal defined for transmitting by a UE 104, such as a SRS.

In method 600, at Block 604, feedback for the reference signal indicating a first precoder for communicating with the transmitting node in the wideband can be transmitted to the transmitting node. In an aspect, feedback component 354, e.g., in conjunction with processor(s) 312, memory/memories 316, transceiver 302, communication receiving component 342, etc., can transmit, to the transmitting node, feedback for the reference signal indicating the first precoder for communicating with the transmitting node in the wideband. For example, the feedback can include a measurement of the received RS, a measurement of a channel based on the received RS, a recommended precoder selected based on the measurement of the channel or the received RS, etc. In an example, where the receiving node 300 is a UE 104, feedback component 354 can transmit the feedback over feedback resources configured by the base station 102 (e.g., in uplink control information (UCI)). In another example, where the receiving node 300 is a base station 102, feedback component 354 can transmit the feedback in scheduling uplink transmission resources (e.g., in DCI scheduling resources). For example, the DCI can include an indicator of the recommended precoder for the wideband.

In method 500, at Block 504, feedback for the reference signal indicating a first precoder for communicating with the receiving node in a wideband can be received from the receiving node. In an aspect, feedback processing component 452, e.g., in conjunction with processor(s) 412, memory/memories 416, transceiver 402, communication transmitting component 442, etc., can receive, from the receiving node, feedback for the reference signal indicating the first precoder for communicating with the receiving node in the wideband. For example, the feedback can include a measurement of the RS performed by the receiving node, a measurement of a channel based on the RS performed by the receiving node, a recommended precoder selected by the receiving node based on the measurement of the channel or the received RS, etc., as described. In an example, feedback processing component 452 can obtain the feedback and process the feedback, and precoder selecting component 454 can select a wideband precoder to use for communicating with the receiving node based on the feedback. For example, precoder selecting component 454 can select the recommended precoder selected by the receiving node or another precoder.

In method 500, at Block 506, communications can be transmitted to the receiving node in a plurality of subbands of the wideband using a plurality of precoders, where each precoder in the plurality of precoders is based at least in part on a wideband precoder that is based on the first precoder and a subband-specific precoder for a corresponding subband in the plurality of subbands. In an aspect, communication transmitting component 442, e.g., in conjunction with processor(s) 412, memory/memories 416, transceiver 402, precoder selecting component 454, etc., can transmit communications to the receiving node in the plurality of subbands of the wideband using the plurality of precoders, where each precoder in the plurality of precoders is based at least in part on the wideband precoder that is based on the first precoder and the subband-specific precoder for a corresponding subband in the plurality of subbands. In an example, the subband-specific precoder for multiple subbands can be different. In an example, precoder selecting component 454 can select the subband-specific precoders based on a configured or defined pattern over the plurality of subbands. In either case, precoder selecting component 454 can compute or otherwise determine each precoder for each subband based on, or as a function of, the wideband precoder and a subband-specific precoder for the given subband.

In a specific example, precoder selecting component 454 can select the wideband precoder based on the feedback, as described, and can select subband-specific precoders for each of the plurality of subbands in the wideband. For example, for a given number, N, of subbands in the wideband, precoder selecting component 454 can select a subband-specific precoder W2(i) for a given subband i in N. Thus, precoder selecting component 454 can select subband-specific precoders W2(1), W2(2), . . . , W2(N), for subbands 1, 2, . . . N, in the wideband. In one example, precoder selecting component 454 can then select the precoder for each subband as a function of the wideband precoder and the corresponding subband-specific precoder. For example, precoder selecting component 454 can compute the precoder for each subband by performing matrix multiplication of the wideband precoder, W1, and the subband-specific precoder W2(1), W2(2), . . . , W2(N), for each subband. In this example, precoder selecting component 454 can compute the precoder for subband i as W(i)=W1*W2(i) for each subband i in N for the wideband.

In method 600, at Block 606, communications can be received from the transmitting node in a plurality of subbands of the wideband using a plurality of precoders, where each precoder in the plurality of precoders is based at least in part on a wideband precoder that is based on the first precoder and a subband-specific precoder for a corresponding subband in the plurality of subbands. In an aspect, communication receiving component 342, e.g., in conjunction with processor(s) 312, memory/memories 316, transceiver 302, etc., can receiving communications from the transmitting node in the plurality of subbands of the wideband using the plurality of precoders, where each precoder in the plurality of precoders is based at least in part on the wideband precoder that is based on the first precoder and the subband-specific precoder for a corresponding subband in the plurality of subbands. In an example, the subband-specific precoder for multiple subbands can be different, as described, and can be selected as a function of the wideband precoder and subband-specific precoders for each subband.

In an example, such as for downlink MIMO precoding, the UE 104, as the receiving node 300, can specify one or more cycling patterns to be used to cycle the subband-specific precoders over the plurality of subbands, as described above. For example, the UE 104 can evaluate and select a best beam pattern, which may be based on channel conditions, historical patterns and associated communication metrics when using the patterns, etc. For example, the patterns may include an indication of multiple precoders (e.g., precoding matrices) to be applied in each of a subset of the plurality of subbands. In one example, a given pattern can indicate a number of subband-specific precoders that is less than a number of subbands, in which case precoder selecting component 454 can cycle through the pattern for the plurality of subbands.

In method 600, optionally at Block 608, an indication of a recommended pattern for cycling the subband-specific precoders over the plurality of subbands can be transmitted to the transmitting node. In an aspect, configuring component 356, e.g., in conjunction with processor(s) 312, memory/memories 316, transceiver 302, communication receiving component 342, etc., can transmit, to the transmitting node, the indication of the recommended pattern for cycling the subband-specific precoders over the plurality of subbands. For example, configuring component 356 can transmit (e.g., in UCI), in the feedback transmitted at Block 604, or in other signaling) an indication of the pattern, where the indication can include the specific precoders in the pattern, an index of a number of configured patterns configured for the receiving node by the transmitting node, etc.

In method 600, optionally at Block 610, a configuration of one or more patterns for cycling the subband-specific precoders over the plurality of subbands can be received from the transmitting node. In an aspect, configuring component 356, e.g., in conjunction with processor(s) 312, memory/memories 316, transceiver 302, communication receiving component 342, etc., can receive, from the transmitting node, the configuration of one or more patterns for cycling the subband-specific precoders over the plurality of subbands. For example, configuring component 356 can receive the configuration in radio resource control (RRC) signaling, media access control (MAC)-control element (CE) signaling, downlink control information (DCI), and/or the like. In an example, configuring component 356 can select from the multiple patterns, based on evaluating the multiple patterns as described, and can transmit an indication of one of the multiple patterns to the transmitting node (e.g., by transmitting an index of the pattern within the multiple patterns).

Similarly, in downlink MIMO, in method 500, optionally at Block 508, an indication of a recommended pattern for cycling the subband-specific precoders over the plurality of subbands can be received from the receiving node. In an aspect, configuring component 456, e.g., in conjunction with processor(s) 412, memory/memories 416, transceiver 402, communication transmitting component 442, etc., can receiving, from the receiving node, the indication of the recommended pattern for cycling the subband-specific precoders over the plurality of subbands. For example, configuring component 456 can receive (e.g., in UCI, in the feedback received at Block 504, or in other signaling) an indication of the pattern, where the indication can include the specific precoders in the pattern, an index of a number of configured patterns configured for the receiving node by the transmitting node, etc. In an example, precoder selecting component 454 can select the subband-specific precoders (e.g., W2(i) for each subband i) based on the indicated pattern (e.g., as the indicated pattern or a different pattern selected based on the indicated pattern).

In method 500, optionally at Block 510, a configuration of one or more patterns for cycling the subband-specific precoders over the plurality of subbands can be transmitted to the receiving node. In an aspect, configuring component 456, e.g., in conjunction with processor(s) 412, memory/memories 416, transceiver 402, communication transmitting component 442, etc., can transmit, to the receiving node, the configuration of one or more patterns for cycling the subband-specific precoders over the plurality of subbands. For example, configuring component 456 can transmit the configuration in RRC signaling, MAC-CE signaling, DCI, and/or the like. In an example, configuring component 456 can then receive, from the receiving node, the indication of the selected pattern as an index of the pattern within the multiple patterns configured for the receiving node.

In another example, for downlink or uplink MIMO, the reference signal transmission can be configured for the UE 104 by the base station 102. For example, for downlink MIMO, the base station 102, as the transmitting node 400, can configure the CSI-RS transmission for the UE 104, as the receiving node 300, to receive. In this example, in method 500, optionally at Block 512, a configuration configuring the reference signal for transmitting to the receiving node can be transmitted to the receiving node. In an aspect, configuring component 456, e.g., in conjunction with processor(s) 412, memory/memories 416, transceiver 402, communication transmitting component 442, etc., can transmit, to the receiving node, the configuration configuring the reference signal (e.g., CSI-RS) for transmitting to the receiving node. For example, the configuration can include an indication of resources over which to receive the CSI-RS. In addition, for example, the configuration can include one or more parameters related to the hybrid closed-loop and open-loop precoding scheme described herein, such as an indication of subband-specific precoders that the receiving node 300 (e.g., UE 104) can use or from which the receiving node 300 can select in reporting which subband-specific precoders should be used, multiple possible patterns of subband-specific precoders from which the receiving node 300 can select, etc. In an example, as described, the receiving node 300 can transmit an indication of selected subband-specific precoders or a selected pattern (e.g., as an index or other identifier of the pattern within the multiple patterns) in feedback received at Block 504.

In this example, in method 600, optionally at Block 612, a configuration configuring the reference signal for receiving from the transmitting node can be received from the transmitting node. In an aspect, configuring component 356, e.g., in conjunction with processor(s) 312, memory/memories 316, transceiver 302, communication receiving component 342, etc., can receive, from the transmitting node, the configuration configuring the reference signal (e.g., CSI-RS) for receiving from the transmitting node. For example, the configuration can include an indication of resources over which to receive the CSI-RS, as described. In addition, for example, the configuration can include one or more parameters related to the hybrid closed-loop and open-loop precoding scheme described herein, such as an indication of subband-specific precoders, an indication of patterns of subband-specific precoders, etc., which the receiving node 300 can use to report selected subband-specific precoders or a pattern of subband-specific precoders in feedback transmitted at Block 604.

In another example, for uplink MIMO, the base station 102, as the receiving node 300, can configure the SRS transmission for the UE 104, as transmitting node 400, to transmit. In this example, in method 500, optionally at Block 514, a configuration configuring the reference signal for transmitting to the receiving node can be received from the receiving node. In an aspect, configuring component 456, e.g., in conjunction with processor(s) 412, memory/memories 416, transceiver 402, communication transmitting component 442, etc., of a UE 104 as transmitting node 400, can receive, from the receiving node, the configuration configuring the reference signal (e.g., SRS) for transmitting to the receiving node. For example, the configuration can include an indication of resources over which to transmit the SRS. In addition, for example, the configuration can include one or more parameters related to the hybrid closed-loop and open-loop precoding scheme described herein, such as an indication of subband-specific precoders that the transmitting node 400 (e.g., UE 104) can use or from which the transmitting node 400 can select in transmitting uplink communications, multiple possible patterns of subband-specific precoders from which the transmitting node 400 can select, etc. In an example, as described, the transmitting node 400 can receive feedback from the receiving node 300 (e.g., base station 102) at Block 504, which can indicate a selected subband-specific precoder or a selected pattern, and the transmitting node 400 can interpret the indication based on the configuration of precoders (e.g., as an index or other identifier of the pattern within the multiple patterns).

In this example, in method 600, optionally at Block 614, a configuration configuring the reference signal for receiving from the transmitting node can be transmitted to the transmitting node. In an aspect, configuring component 356, e.g., in conjunction with processor(s) 312, memory/memories 316, transceiver 302, communication receiving component 342, etc., can transmit, to the transmitting node, the configuration configuring the reference signal (e.g., SRS) for receiving from the transmitting node. For example, the configuration can include an indication of resources over which to transmit the SRS, as described. In addition, for example, the configuration can include one or more parameters related to the hybrid closed-loop and open-loop precoding scheme described herein, such as an indication of subband-specific precoders, an indication of patterns of subband-specific precoders, etc., which the transmitting node 400 (e.g., UE 104) can use to precode uplink transmissions. The receiving node 300 (e.g., base station 102) can indicate a selected subband-specific precoder or a pattern of subband-specific precoders in feedback transmitted at Block 604.

In addition, in this example, the receiving node 300 (e.g., base station 102) can recommend subband-specific precoders or a pattern of subband-specific precoders (e.g., as an index or other identifier of a pattern within multiple configured patterns) in the DCI used to schedule uplink transmissions. In this example, in transmitting the feedback at Block 604, optionally at Block 616, a DCI scheduling a physical uplink shared channel (PUSCH) transmission can be transmitted, where the DCI indicates the wideband precoder and one of the plurality of patterns for cycling the plurality of subband-specific precoders over the plurality of subbands. In an aspect, feedback component 354, e.g., in conjunction with processor(s) 312, memory/memories 316, transceiver 302, communication receiving component 342, etc., can transmit the DCI scheduling the PUSCH transmission, where the DCI indicates the wideband precoder and one of the plurality of patterns for cycling the plurality of subband-specific precoders over the plurality of subbands. In an example, receiving node 300 can evaluate the subband-specific precoders and determine which precoder pattern the transmitting node 400 should use, and can accordingly indicate the pattern in the DCI. This can allow for transmitting a fixed-size DCI, which can include a fixed number of bits for indicating the wideband precoder and a fixed number of bits for indicating the pattern of subband-specific precoders (e.g., as an index within the configured patterns).

In this example, in receiving the feedback at Block 504, optionally at Block 516, a DCI scheduling a PUSCH transmission can be received, where the DCI indicates the wideband precoder and one of the plurality of patterns for cycling the plurality of subband-specific precoders over the plurality of subbands. In an aspect, feedback processing component 452, e.g., in conjunction with processor(s) 412, memory/memories 416, transceiver 402, communication transmitting component 442, etc., can receive the DCI scheduling the PUSCH transmission, where the DCI indicates the wideband precoder and one of the plurality of patterns for cycling the plurality of subband-specific precoders over the plurality of subbands. In this example, feedback processing component 452 can receive the DCI and determine the wideband precoder and pattern of subband-specific precoders based on the index or other identifier indicated in the DCI, as described.

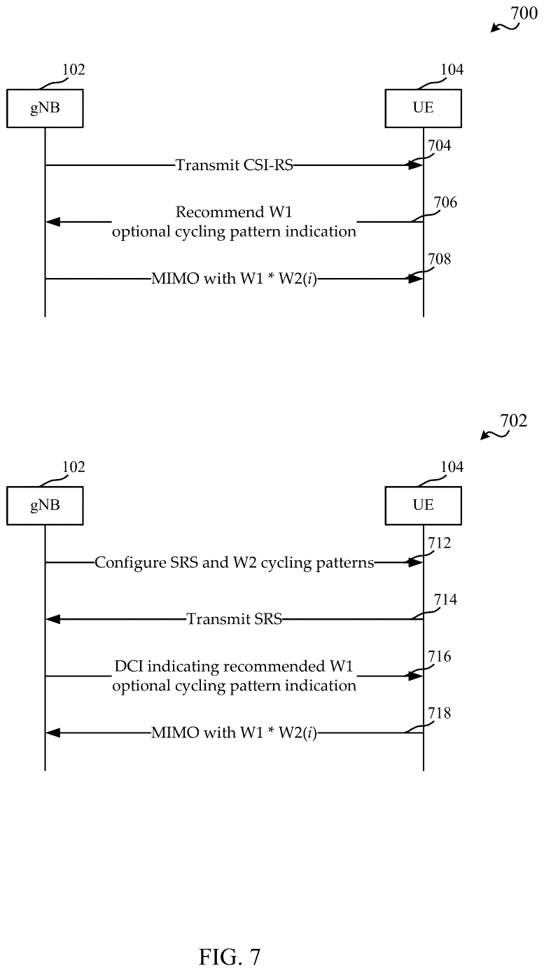

FIG. 7 illustrates examples of systems 700 and 702 for performing DL and UL MIMO using a hybrid closed-loop and open-loop precoding technique, as described herein. System 700 includes a gNB 102 and UE 104 that can communicate using DL MIMO. The gNB 102 can transmit CSI-RS at 704. In an example, as described above gNB 102 can configure multiple cycling patterns for W2 (e.g., for subband-specific precoders, as described above). UE 104 can measure CSI-RS channel, and calculate wideband precoder W1. UE 104 may also evaluate the multiple cycling patterns for W2 and select a pattern (e.g., a best or most optimal pattern). UE 104 can transmit feedback to the gNB 102 with the recommend W1 and/or optionally an indication (e.g., index or other identifier) of the recommended pattern for cycling of W2 at 706. gNB 102 can transmit MIMO with W1*W2 (i) precoder used for each subband i at 708, as described.

System 702 includes a gNB 102 and UE 104 that can communicate using UL MIMO. gNB 102 can configure SRS and/or multiple cycling patterns for W2 (e.g., for subband-specific precoders, as described above) to the UE 104 at 712. UE 104 can transmit SRS based on the configuration at 714. gNB 102 can measure SRS channel, and calculate wideband precoder W1. gNB 102 evaluate the multiple cycling patterns for W2 and select a pattern (e.g., a best or most optimal pattern). gNB 102 can transmit DCI scheduling PUSCH to the UE 104 at 716, which may indicate the recommend W1 and/or optionally an index of the recommended pattern for cycling of W2. UE 104 can transmit MIMO with W1*W2 (i) precoder used for each subband i at 718, as described.

FIG. 8 is a block diagram of a MIMO communication system 800 including a base station 102 and a UE 104. The MIMO communication system 800 may illustrate aspects of the wireless communication access network 100 described with reference to FIG. 1. The base station 102 may be an example of aspects of the base station 102 described with reference to FIG. 1. The base station 102 may be equipped with antennas 834 and 835, and the UE 104 may be equipped with antennas 852 and 853. In the MIMO communication system 800, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor(s) 820 may receive data from a data source. The transmit processor(s) 820 may process the data. The transmit processor(s) 820 may also generate control symbols or reference symbols. A transmit MIMO processor(s) 830 may perform spatial processing (e.g., precoding) on data symbols, control symbols, or reference symbols, if applicable, and may provide output symbol streams to the transmit modulator/demodulators 832 and 833. Each modulator/demodulator 832 through 833 may process a respective output symbol stream (e.g., for OFDM, etc.) to obtain an output sample stream. Each modulator/demodulator 832 through 833 may further process (e.g., convert to analog, amplify, filter, and upconvert) the output sample stream to obtain a DL signal. In one example, DL signals from modulator/demodulators 832 and 833 may be transmitted via the antennas 834 and 835, respectively.

The UE 104 may be an example of aspects of the UEs 104 described with reference to FIGS. 1 and 3. At the UE 104, the UE antennas 852 and 853 may receive the DL signals from the base station 102 and may provide the received signals to the modulator/demodulators 854 and 855, respectively. Each modulator/demodulator 854 through 855 may condition (e.g., filter, amplify, downconvert, and digitize) a respective received signal to obtain input samples. Each modulator/demodulator 854 through 855 may further process the input samples (e.g., for OFDM, etc.) to obtain received symbols. A MIMO detector 856 may obtain received symbols from the modulator/demodulators 854 and 855, perform MIMO detection on the received symbols, if applicable, and provide detected symbols. A receive (Rx) processor(s) 858 may process (e.g., demodulate, deinterleave, and decode) the detected symbols, providing decoded data for the UE 104 to a data output, and provide decoded control information to a processor(s) 880, or memory/memories 882.

The processor(s) 880 may in some cases execute stored instructions to instantiate a communication receiving component 342 (see e.g., FIGS. 1 and 3).

On the uplink (UL), at the UE 104, a transmit processor(s) 864 may receive and process data from a data source. The transmit processor(s) 864 may also generate reference symbols for a reference signal. The symbols from the transmit processor(s) 864 may be precoded by a transmit MIMO processor(s) 866 if applicable, further processed by the modulator/demodulators 854 and 855 (e.g., for single carrier-FDMA, etc.), and be transmitted to the base station 102 in accordance with the communication parameters received from the base station 102. At the base station 102, the UL signals from the UE 104 may be received by the antennas 834 and 835, processed by the modulator/demodulators 832 and 833, detected by a MIMO detector 836 if applicable, and further processed by a receive processor(s) 838. The receive processor(s) 838 may provide decoded data to a data output and to the processor(s) 840 or memory/memories 842.

The processor(s) 840 may in some cases execute stored instructions to instantiate a communication transmitting component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 800. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 800.

The following aspects are illustrative only and aspects thereof may be combined with aspects of other embodiments or teaching described herein, without limitation.

Aspect 1 is a method for wireless communication including transmitting, by a first node, a reference signal to a second node, receiving, from the second node, feedback for the reference signal indicating a first precoder for communicating with the second node in a wideband, and transmitting communications to the second node in a plurality of subbands of the wideband using a plurality of precoders, where each precoder of the plurality of precoders is based at least in part on a wideband precoder that is based on the first precoder and a subband-specific precoder for a corresponding subband in the plurality of subbands, where a first subband precoder of the plurality of precoders for a first subband of the plurality of subbands is different from a second subband precoder of the plurality of precoders for a second subband of the plurality of subbands.

In Aspect 2, the method of Aspect 1 includes where each of the plurality of precoders is the wideband precoder multiplied by the subband-specific precoder for the corresponding subband in the plurality of subbands.

In Aspect 3, the method of any of Aspects 1 or 2 includes where the subband-specific precoders are based on a pattern for cycling the subband-specific precoders over the plurality of subbands.

In Aspect 4, the method of any of Aspects 1 to 3 includes transmitting, to the second node, a configuration of one or more patterns for cycling the subband-specific precoders over the plurality of subbands.

In Aspect 5, the method of any of Aspects 1 to 4 includes receiving, from the second node, an indication of a recommended pattern for cycling the subband-specific precoders over the plurality subbands, where the subband-specific precoder for each of the plurality of subbands is based on the recommended pattern.

In Aspect 6, the method of any of Aspects 1 to 5 includes where the reference signal is a CSI-RS.

In Aspect 7, the method of any of Aspects 1 to 6 includes receiving, from the second node, a configuration configuring the reference signal for transmitting to the second node.

In Aspect 8, the method of Aspect 7 includes where the configuration includes an indication of a plurality of patterns for cycling a plurality of subband-specific precoders, including the subband-specific precoder, over the plurality of subbands.

In Aspect 9, the method of Aspect 8 includes receiving a DCI scheduling a PUSCH transmission, where the DCI indicates the wideband precoder and one of the plurality of patterns for cycling the plurality of subband-specific precoders over the plurality of subbands.

In Aspect 10, the method of any of Aspects 1 to 9 includes where the reference signal is a SRS.

Aspect 11 is a method for wireless communication including receiving, by a first node, a reference signal transmitted by a second node, transmitting, based on measuring the reference signal, feedback indicating a first precoder for communicating with the second node in a wideband, and receiving communications from the second node in a plurality of subbands of the wideband using a plurality of precoders, where each precoder of the plurality of precoders is based at least in part on a wideband precoder that is based on the first precoder and a subband-specific precoder for a corresponding subband in the plurality of subbands, where a first subband precoder of the plurality of precoders for a first subband of the plurality of subbands is different from a second subband precoder of the plurality of precoders for a second subband of the plurality of subbands.

In Aspect 12, the method of Aspect 11 includes where each of the plurality of precoders is the wideband precoder multiplied by the subband-specific precoder for the corresponding subband in the plurality of subbands.

In Aspect 13, the method of any of Aspects 11 or 12 includes where the subband-specific precoders are based on a pattern for cycling the subband-specific precoders over the plurality of subbands.

In Aspect 14, the method of any of Aspects 11 to 13 includes receiving, from the second node, a configuration of one or more patterns for cycling the subband-specific precoders over the plurality of subbands.

In Aspect 15, the method of any of Aspects 11 to 14 includes transmitting, to the second node, an indication of a recommended pattern for cycling the subband-specific precoders over the plurality of subbands, where the subband-specific precoder for each of the plurality of subbands is based on the recommended pattern.

In Aspect 16, the method of any of Aspects 11 to 15 includes where the reference signal is a CSI-RS.

In Aspect 17, the method of any of Aspects 11 to 16 includes transmitting, to the second node, a configuration configuring the reference signal for transmitting to the second node.

In Aspect 18, the method of Aspect 17 includes where the configuration includes an indication of a plurality of patterns for cycling a plurality of subband-specific precoders, including the subband-specific precoder, over the plurality of subbands.

In Aspect 19, the method of Aspect 18 includes transmitting a DCI scheduling a PUSCH transmission, where the DCI indicates the wideband precoder and one of the plurality of patterns for cycling the plurality of subband-specific precoders over the plurality of subbands.

In Aspect 20, the method of any of Aspects 11 to 19 includes where the reference signal is a SRS.

Aspect 21 is an apparatus for wireless communication including one or more memories configured to store instructions, and one or more processors communicatively coupled with the one or more memories, where the one or more processors are configured to execute the instructions to cause the apparatus to perform any of the methods of Aspects 1 to 20.

Aspect 22 is an apparatus for wireless communication including means for performing any of the methods of Aspects 1 to 20.

Aspect 23 is one or more computer-readable media including code executable by one or more processors for wireless communications, the code including code for performing any of the methods of Aspects 1 to 20.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
transmit a reference signal to a node;
receive, from the node, feedback for the reference signal indicating a first precoder for communicating with the node in a wideband; and
transmit communications to the node in a plurality of subbands of the wideband using a plurality of precoders, wherein each precoder of the plurality of precoders is based at least in part on a wideband precoder that is based on the first precoder and a subband-specific precoder for a corresponding subband in the plurality of subbands,
wherein a first subband precoder of the plurality of precoders for a first subband of the plurality of subbands is different from a second subband precoder of the plurality of precoders for a second subband of the plurality of subbands.

2. The apparatus of claim 1, wherein each of the plurality of precoders is the wideband precoder multiplied by the subband-specific precoder for the corresponding subband in the plurality of subbands.

3. The apparatus of claim 1, wherein the subband-specific precoders are based on a pattern for cycling the subband-specific precoders over the plurality of subbands.

4. The apparatus of claim 1, wherein the one or more processors are, individually or in combination, configured to execute the instructions to cause the apparatus to transmit, to the node, a configuration of one or more patterns for cycling the subband-specific precoders over the plurality of subbands.

5. The apparatus of claim 1, wherein the one or more processors are, individually or in combination, configured to execute the instructions to cause the apparatus to receive, from the node, an indication of a recommended pattern for cycling the subband-specific precoders over the plurality subbands, wherein the subband-specific precoder for each of the plurality of subbands is based on the recommended pattern.

6. The apparatus of claim 1, wherein the reference signal is a channel state information reference signal (CSI-RS).

7. The apparatus of claim 1, wherein the one or more processors are, individually or in combination, configured to execute the instructions to cause the apparatus to receive, from the node, a configuration configuring the reference signal for transmitting to the node.

8. The apparatus of claim 7, wherein the configuration includes an indication of a plurality of patterns for cycling a plurality of subband-specific precoders, including the subband-specific precoder, over the plurality of subbands.

9. The apparatus of claim 8, wherein the one or more processors are, individually or in combination, configured to execute the instructions to cause the apparatus to receive a downlink control information (DCI) scheduling a physical uplink shared channel (PUSCH) transmission, wherein the DCI indicates the wideband precoder and one of the plurality of patterns for cycling the plurality of subband-specific precoders over the plurality of subbands.

10. The apparatus of claim 1, wherein the reference signal is a sounding reference signal (SRS).

11. An apparatus for wireless communication, comprising:
a transceiver;
one or more memories configured to, individually or in combination, store instructions; and
one or more processors communicatively coupled with the one or more memories, wherein the one or more processors are, individually or in combination, configured to execute the instructions to cause the apparatus to:
receive a reference signal transmitted by a node;
transmitting, based on measuring the reference signal, feedback indicating a first precoder for communicating with the node in a wideband; and
receiving communications from the node in a plurality of subbands of the wideband using a plurality of precoders, wherein each precoder of the plurality of precoders is based at least in part on a wideband precoder that is based on the first precoder and a subband-specific precoder for a corresponding subband in the plurality of subbands,
wherein a first subband precoder of the plurality of precoders for a first subband of the plurality of subbands is different from a second subband precoder of the plurality of precoders for a second subband of the plurality of subbands.

12. The apparatus of claim 11, wherein each of the plurality of precoders is the wideband precoder multiplied by the subband-specific precoder for the corresponding subband in the plurality of subbands.

13. The apparatus of claim 11, wherein the subband-specific precoders are based on a pattern for cycling the subband-specific precoders over the plurality of subbands.

14. The apparatus of claim 11, wherein the one or more processors are, individually or in combination, configured to execute the instructions to cause the apparatus to receive, from the node, a configuration of one or more patterns for cycling the subband-specific precoders over the plurality of subbands.

15. The apparatus of claim 11, wherein the one or more processors are, individually or in combination, configured to execute the instructions to cause the apparatus to transmit, to the node, an indication of a recommended pattern for cycling the subband-specific precoders over the plurality of subbands, wherein the subband-specific precoder for each of the plurality of subbands is based on the recommended pattern.

16. The apparatus of claim 11, wherein the reference signal is a channel state information reference signal (CSI-RS).

17. The apparatus of claim 11, wherein the one or more processors are, individually or in combination, configured to execute the instructions to cause the apparatus to transmit, to the node, a configuration configuring the reference signal for transmitting to the node.

18. The apparatus of claim 17, wherein the configuration includes an indication of a plurality of patterns for cycling a plurality of subband-specific precoders, including the subband-specific precoder, over the plurality of subbands.

19. The apparatus of claim 18, wherein the one or more processors are, individually or in combination, configured to execute the instructions to cause the apparatus to transmit a downlink control information (DCI) scheduling a physical uplink shared channel (PUSCH) transmission, wherein the DCI indicates the wideband precoder and one of the plurality of patterns for cycling the plurality of subband-specific precoders over the plurality of subbands.

20. The apparatus of claim 11, wherein the reference signal is a sounding reference signal (SRS).

21-30. (canceled)
